(19) United States
(12) Patent Application Publication
(10) Pub. No.: US 2004/0230566 A1
(43) Pub. Date: Nov. 18, 2004

(54) Web-based customized information retrieval and delivery method and system

(76) Inventors: Srinivas Balijepalli, Devon, PA (US); Joshua M. Kopelman, Wynnewood, PA (US); Arturo Perez, Green Lane, PA (US); Michael A. Puscar, King of Prussia, PA (US); Shuchun Zhang, Secane, PA (US)

Correspondence Address: Daniel H. Golub, 1701 Market Street, Philadelphia, PA, 19103, US

(21) Appl. No.: 10/664,175

(22) Filed: Sep. 17, 2003

Related U.S. Application Data
(63) Continuation of application No. 09/378,031, filed on Aug. 20, 1999, now abandoned.

(51) Int. Cl. G06F 7/00

(52) U.S. Cl. 707/3

(57) ABSTRACT

A web-based multi-user system and method for identifying, retrieving, and delivering information corresponding to items contained in a user search list from two or more information sources on the World Wide Web (WWW) is provided. The system includes a central server that periodically searches the information sources on the WWW for information corresponding to the items contained in the user search list. The central server retrieves the information onto a storage database where a determination is made as to whether the information is current. The central server electronically delivers only the current information to the user. The system and method therefore provides to the user automatic and periodic electronic reports containing only current or updated information corresponding to items contained in the user search list that the user desires to track.

### FIELD OF THE INVENTION

The present invention is directed to a customized method and system for retrieving and delivering information corresponding to a user search inquiry. More particularly, the present invention is directed to an automated multi-user method and system for identifying, retrieving, and delivering information corresponding to items contained in the user search list from various content sources on the World Wide Web (WWW).

### BACKGROUND OF THE INVENTION

Information retrieval systems are designed to retrieve and store information provided by online content sources. Information retrieval engines are provided within prior art information retrieval systems in order to receive search queries from users and perform searches of the content sources. It is an object of most information retrieval systems to provide the user with all information relevant to the user's query. However, the existing searching and retrieval systems are not adapted to identify and deliver only the most recent information yielded by the query search. Such systems typically return query results to the user in such a way that the user must retrieve and view all the information returned by the query regardless if the information is outdated. It is therefore desirable to have an information searching and retrieval system which not only returns relevant information to the user based on a query search, but identifies and returns only recent information to the user.

In the existing systems, a user manually inputs a single query item into the search engine in order to perform a search of a single content source for information corresponding to the query item. Such systems, however, only provide a single, immediate delivery of information to the user in response to the manual search query. This manual process is likely to become tedious to the user and will probably result in the user neglecting to use the system. The systems also lack a search of more than one content source for information thereby limiting the search results. It is therefore desirable to provide to the user not only a system that periodically searches a content source and retrieves and delivers the information to the user on an automatic basis, but a system that searches a plurality of content sources for the information. Further, in the existing systems, a user may input only a single query item to be searched at a time, thereby resulting in an inefficient process if the user desires to retrieve information corresponding to more than one item. It is therefore also desirable to provide a system which accepts a query list of a plurality of query items from a user to be searched for retrieval and delivery of information corresponding to the plurality of items contained in the query list.

It is therefore an object of the present invention to provide an information searching and retrieval system which not only returns relevant information to the user based on a query search, but identifies and returns only recent information to the user.

It is a further object of the present invention to provide a system that not only periodically searches a content source and retrieves and delivers the information to the user on an automatic basis, but a system that searches a plurality of content sources for the information.

It is a still further object of the present invention to provide a system which accepts a query list of a plurality of items from a user to be searched for retrieval and delivery of information corresponding to the plurality of items contained in the query list.

These and other objects and advantages of the invention will become more fully apparent from the description and claims which follow or may be learned by the practice of the invention.

### SUMMARY OF THE INVENTION

The present invention is directed to a method and system for automated processing of a search list provided by a remote user, and retrieving and delivering information corresponding to at least one item contained in the search list. The system includes a storage database that stores document meta-data or meta-information in a common format. In data processing, meta-data is definitional data that provides information about, or documentation of, other data managed within an application or environment. Meta-data can include descriptive information about the context, quality, condition, or characteristics of the data. The term “meta-data” is well known to those of ordinary skill in the art. The information that is stored in the database corresponds to results of previous searches using a query. The system also includes a central server that receives a search list provided by the user. The search list includes at least one item. The central server forms the query based on the search list. The central server is capable of servicing a plurality of remote users. Subsequently, the central server periodically initiates a search using the query on two or more information or content sources (e.g. public search engines) on the World Wide Web in order to locate information corresponding to each of the items. The central server retrieves the information, formats the information into a common format, and ascertains whether the information is current by comparing the information in the common format to the information stored in the database in the common format. If the information is current, the central server electronically delivers notification of only the current information to the remote user. Notification of the current information is preferably delivered to the remote user via automated electronic mail. The user can then access a web page displaying the current information via a link in the electronic mail. The central server may perform the periodic searches automatically.

In accordance with a further aspect, the present invention is directed to a computer-readable medium tangibly embodying instructions which, when executed by a computer, implement a process. The process includes the step of receiving, onto a central server that services a plurality of remote users, a search list provided by the user. The search list comprises at least one item. Another step in the process is the formation of a query at the central server based on the search list. The process also includes subsequent steps which are periodically performed. These periodic steps include the following: i) initiating, from the central server, a search using the query on two or more public search engines on the World Wide Web in order to locate information corresponding to each of the items; (ii) retrieving the information with the central server; (iii) formatting said information into a common format using the central server; (iv) ascertaining whether the information is current by comparing the information in the common format to information stored in a storage database in the common format. The information stored in the database corresponds to results of previous searches using the query; and (v) after step (iv), electronically delivering, using the central server, only the information ascertained to be current to the remote user.

In accordance with a still further aspect, the present invention is directed to a method and system for ascertaining whether information retrieved from the World Wide Web is current. The system includes a storage database that stores hashes (described below). The hashes stored in the database correspond to results of previous searches using a query. The system also includes a central server that initiates a search using the query on at least one information source on the World Wide Web in order to locate information corresponding to at least one item from which the query is based. The central server retrieves a portion of the information, composes a hash of the portion, and ascertains whether the information is current by comparing the composed hash to the hashes stored in the database.

In accordance with a still further aspect, the present invention is directed to a method and system for converting a stored document from one extensible markup language (XML) format to another XML format. The system includes a central server that retrieves a document in an input XML format. The document in the input XML format is coded with a document type definition (DTD). The central server converts the document from the input XML format to another XML format using only information derived from the DTD. Preferably, the another XML format is a web distributed data exchange (WDDX) format.

In accordance with a still further aspect, the present invention is directed to a method and system for processing of a search list provided by a remote user, and retrieving information corresponding to at least one item contained in the search list. The system includes a central server that receives a search list provided by the user and comprising at least one item. The central server services a plurality of remote users, forms a query based on the search list, initiates a search using the query on at least one information source on the World Wide Web in order to locate information corresponding to each of the at least one item, and retrieves the information. The central server comprises at least two local servers such that the at least two local servers function as a single virtual server. Each of the at least two servers are located in different locations from one another and are capable of simultaneously retrieving different portions of the information.

In accordance with a still further aspect, the present invention is directed to a method and system for automatically suspending the electronic delivery of information to electronic mail destinations having invalid electronic mail addresses. The system includes a server that attempts to electronically deliver information in the form of a message on a periodic basis to an electronic mail destination using an electronic mail address corresponding to the electronic mail destination, receives a reply message in response to the attempted delivery of the message when the electronic delivery of the message is unsuccessful, extracts the electronic mail address from the reply message, changes the status of the electronic mail address from valid to invalid after a predetermined number of reply messages are received corresponding to the same electronic mail address, and suspends the electronic delivery of information to the electronic mail destination when the status of the electronic mail address is held invalid. The reply message may be a copy of the message attempted to be delivered or may alternatively include therein a statement indicating that the delivery of the message was unsuccessful.

### BRIEF DESCRIPTION OF THE INVENTION

In order that the manner in which the above-recited and other advantages and objects of the invention are obtained and can be appreciated, a more particular description of the invention briefly described above will be rendered by reference to a specific embodiment thereof which is illustrated in the appended drawings. Understanding that these drawings depict only a typical embodiment of the invention and are not therefore to be considered limiting of its scope, the invention and the presently understood best mode thereof will be described and explained with additional specificity and detail through the use of the accompanying drawings.

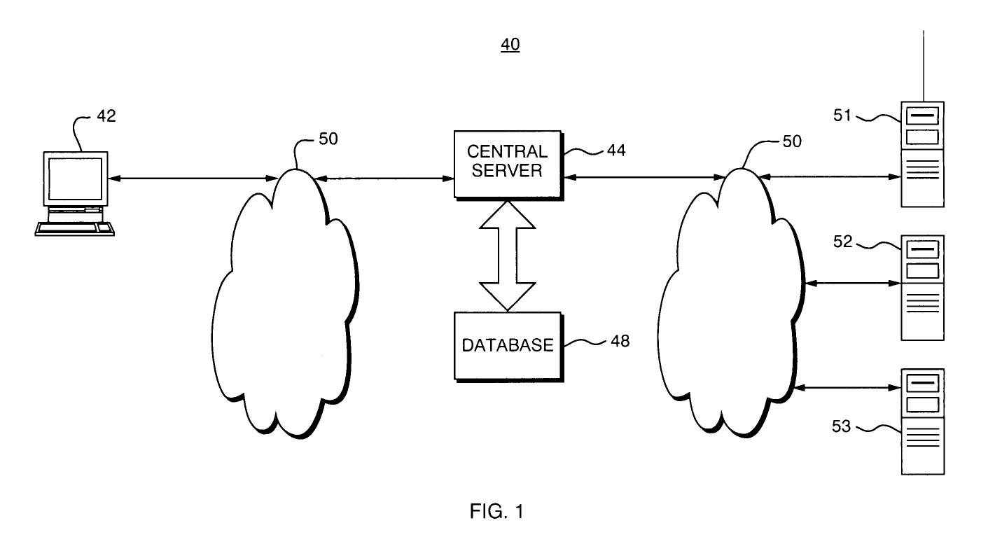

FIG. 1 is a simplified block diagram illustrating an information search, retrieval and delivery system, in accordance with a preferred embodiment of the present invention.

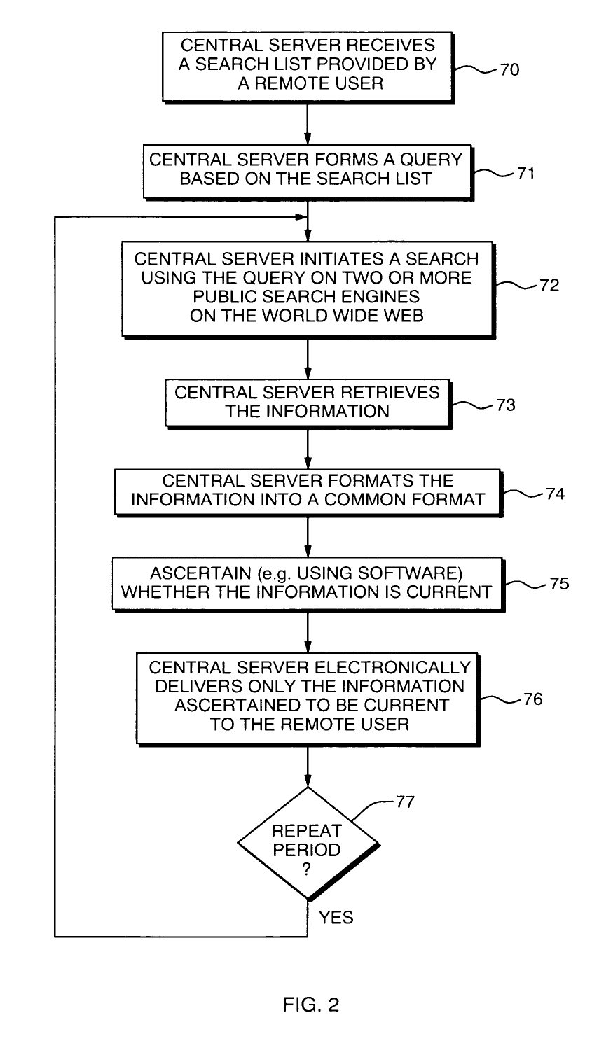

FIG. 2 is a simplified process flow diagram illustrating steps which may be performed with the information search, retrieval and delivery system shown in FIG. 1, in accordance with a preferred embodiment of the present invention.

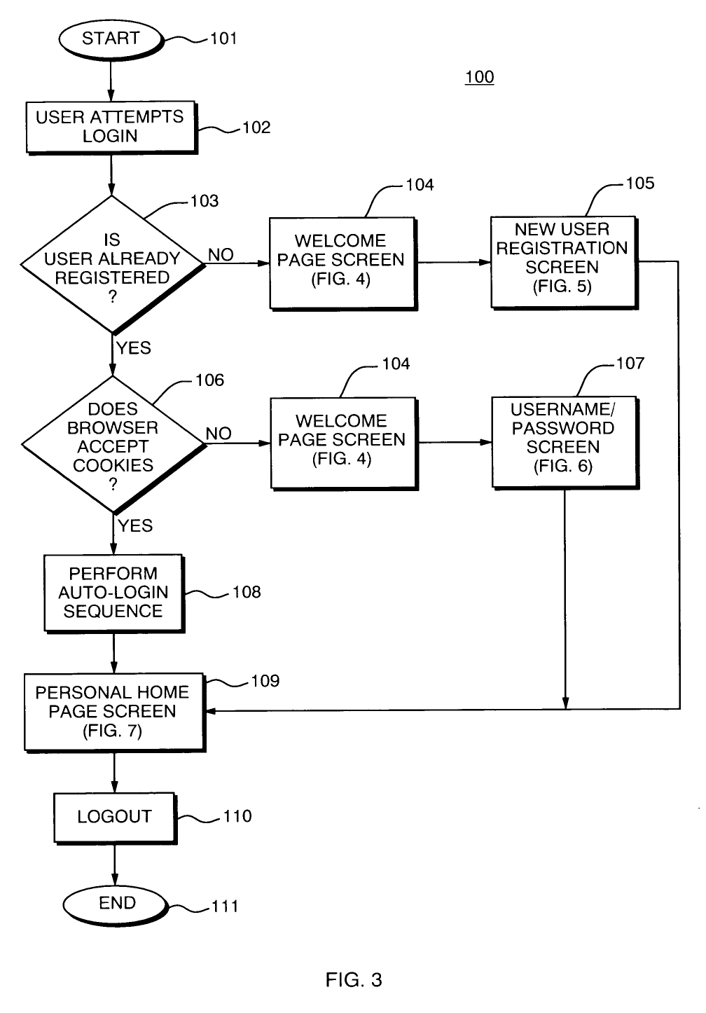

FIG. 3 is a simplified process flow diagram illustrating steps in an online user session which may be performed with the information search, retrieval and delivery system shown in FIG. 1, in accordance with a preferred embodiment of the present invention.

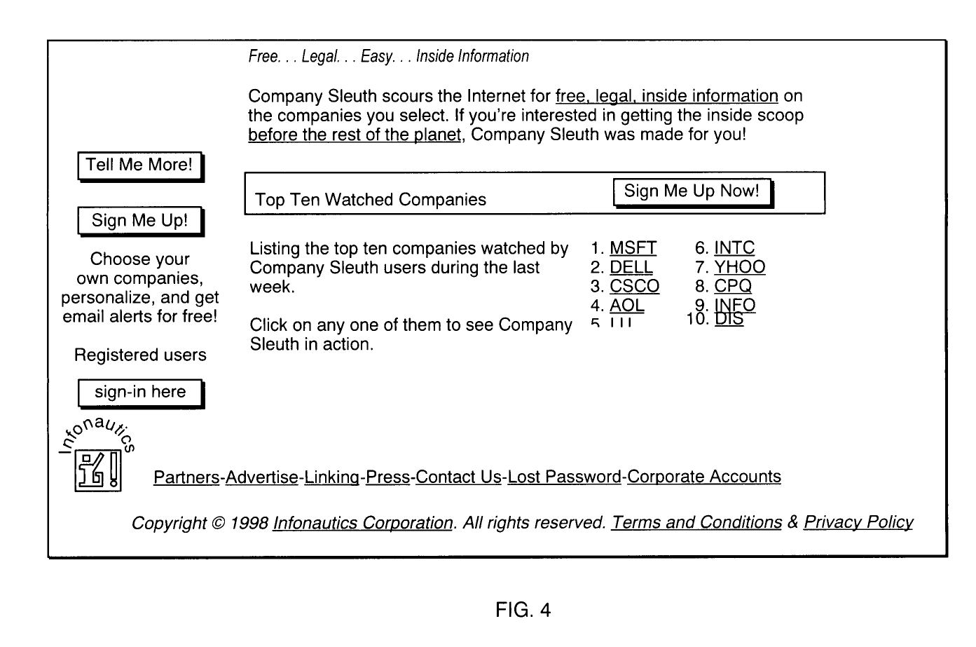

FIG. 4 is an exemplary illustration of a Welcome web page screen from the information search, retrieval and delivery system shown in FIG. 3, in accordance with a preferred embodiment of the present invention.

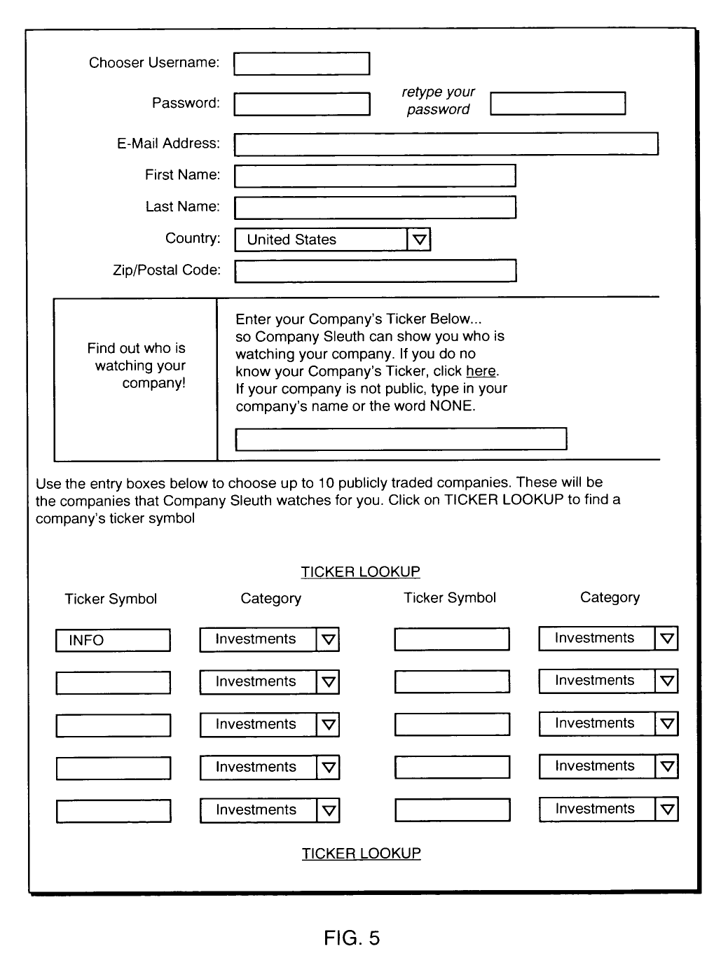

FIG. 5 is an exemplary illustration of a New User Registration web page screen from the information search, retrieval and delivery system shown in FIG. 3, in accordance with a preferred embodiment of the present invention.

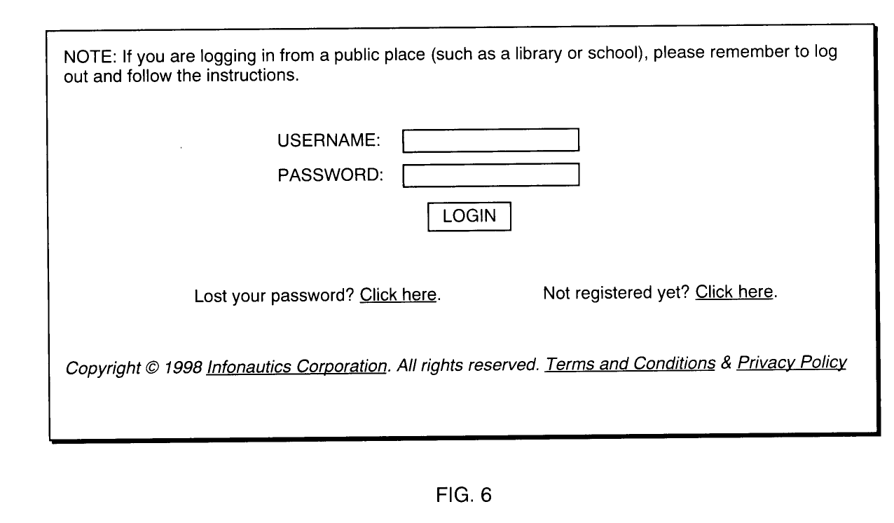

FIG. 6 is an exemplary illustration of a Username/Password web page screen from the information search, retrieval and delivery system shown in FIG. 3, in accordance with a preferred embodiment of the present invention.

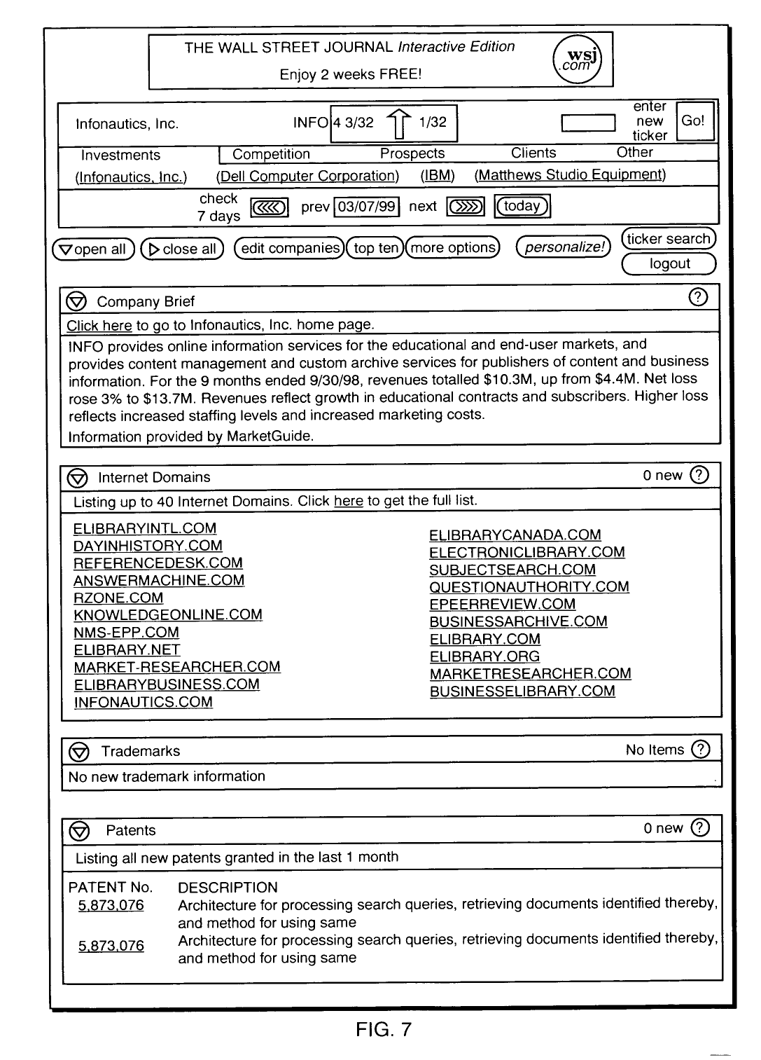

FIG. 7 is an exemplary illustration of a Personal Home web page screen from the information search, retrieval and delivery system shown in FIG. 3, in accordance with a preferred embodiment of the present invention.

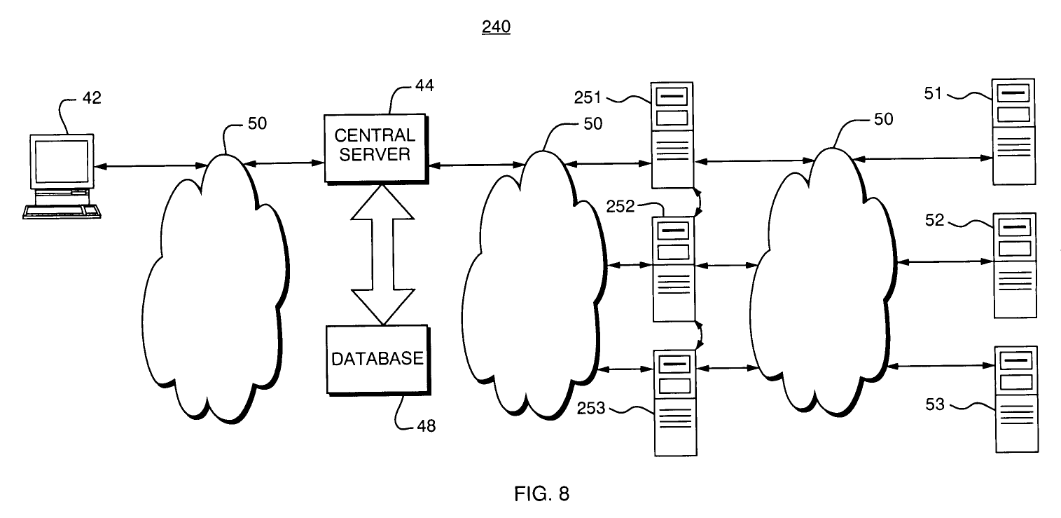

FIG. 8 is a simplified block diagram illustrating an alternative information search, retrieval and delivery system, in accordance with a preferred embodiment of the present invention.

### DETAILED DESCRIPTION OF THE INVENTION

Referring now to FIG. 1, there is shown a simplified block diagram illustrating an information retrieval and delivery system 40, in accordance with a preferred embodiment of the present invention. The information retrieval and delivery system 40 includes a remote user station 42 for viewing information which has been collected from various online content sources 51, 52, 53 and stored in database 48. The content sources 51, 52, 53 are located on the World Wide Web (WWW) 50 and may include public search engines. The user station 42 includes a personal computer (PC). The user, through user station 42, provides a search list including at least one item (described more fully below) to a central server 44 via a communications channel (such as, for example, a large volume public network or the WWW 50) coupled to the central server 44. The central server 44 services a plurality of remote users. A storage database 48 is coupled to the central server 44 and stores information in a common format. The information that is stored in the database corresponds to results of previous searches using a query originating from the user at user station 42. The central server 44 receives the search list provided by the user, forms the query based on the search list, and periodically initiates a search using the query on two or more online content sources 51, 52, 53 on the WWW 50 in order to locate information corresponding to each of the items in the search list, retrieves the information, formats the information into a common format (e.g. using XML format as the storage standard which is explained more fully below), ascertains whether the information is current by comparing the information in the common format to the information stored in the database 48 in the common format, and electronically delivers only the information ascertained to be current to the remote user at user station 42 via the WWW 50.

Referring now to FIG. 2, a preferred method is illustrated that automatically processes the search list provided by the remote user, and that retrieves and delivers information corresponding to the items contained in the search list. The method includes the following steps: receiving, onto the central server, the search list provided by the remote user (step 70); forming the query at the central server based on the search list (step 71); initiating, from the central server, a search using the query on two or more public information sources (e.g. public search engines) on the WWW (step 72) in order to locate information corresponding to each of the items; retrieving, with the central server, the information (step 73); formatting the information into the common format using the central server (step 74); ascertaining (e.g. using software) whether the information is current (step 75) by comparing the information in the common format to information stored in a storage database in the common format. The information stored in the database corresponds to results of previous searches using the query; and after step 75, electronically delivering, using the central server, only the information ascertained to be current to the remote user (step 76). Subsequent step 76, if the user desires to periodically receive the information obtained by the above steps, then the process is repeated beginning at step 72.

Referring now to FIG. 3, there is shown a simplified process flow diagram illustrating an online user session 100 which may be performed with the information retrieval and delivery system shown in FIG. 1, in accordance with a preferred embodiment of the present invention. In step 102 of user session 100, the user attempts to login to an online web site via, for example, a computer terminal. The computer terminal is connected to an online network such as, for example, the WWW. In step 103, a central server determines if the user is already registered with the web site. This determination can be made using any of a number of schemes which are well known to those skilled in the art of online networking. For example, the central server may determine if the user is a registered user by utilizing cookies. Cookies are messages given to a web browser by a web server. The browser stores the messages in a text file called, for example, cookie.txt. The messages are then sent back to the server each time the browser attempts to login and/or each time the browser requests a page from the server. The main purpose of cookies is to identify registered users as well as to prepare customized web pages for them.

If the user attempting to login is not a registered user, then the user is automatically taken to a Welcome web page screen 104 (see also FIG. 4). While on the Welcome web page screen 104, information about the web site (or paths which lead to additional pages having information about the web site) may be viewed along with a list of the top items (e.g. companies) being “tracked” by users of the web site. On the Welcome web page screen 104, an unregistered user may choose to accept a “new user registration” invitation and will be taken through a registration sequence which includes filling out information on an online registration form viewed on a New User Registration screen 105 (see also FIG. 5). Alternatively, on the Welcome web page screen 104, a registered user may choose to take a path to a Username/Password screen 107 (see also FIG. 6) where the user enters their personal username and password. Once the username and password are verified, the user is taken to their Personal Home Page screen 109 (see also FIG. 7 and description below).

The registration sequence comprises three main steps. In the first step, the unregistered user is prompted to input system information on the registration form, The input of the system information involves the unregistered user to select and input a username, password, password hint, and electronic mail (email) address. The information may then be verified before the user is sent to the next step in the registration sequence. The second step in the registration sequence requires the user to input information on the registration form that may optionally be used for demographic-based advertising campaigns. Examples of this type of demographic-based information may be, for example, the user's gender, age, income, occupation, and/or postal code.

In the third step of the registration sequence, the user inputs information which subsequently becomes the user's profile. This involves the user selectively inputting at least one item into a user list (see step 70, FIG. 2). The maximum number of items capable of being input in the user list is previously determined system-wide by internal developers or controllers of the web site. The items input by the user in the user list are saved in the user's profile and are subsequently periodically tracked by the web site. The items in the user's profile that the user wants to track may be, for example, distinct companies (listed by either company name or by the company's ticker symbol), industries, or job formats. Preferably, the items contained in the list are company ticker symbols. The information input by the user for the user's profile may also comprise the selection of online content sources that the user wants the system to search through and retrieve information from for each of the items contained in the user list. The selection of online content sources may be determined by the user for all of the items in the user list. Alternatively, the selection of online content sources may be determined by the user independently for each of the items in the user list. As a further alternative, the selection of online content sources may be predetermined by the internal developers or controllers of the web site for system-wide use by all users of the web site. Preferably, the online content sources are distinct time-sensitive and content-filled public search engines. For example, a search engine which may be used as an online content source for retrieving information related to a company's SEC filings may be obtained from the “EDGAR-Online” search engine found at the URL: http://www.edgar-online.com. Other search engines for retrieving information on SEC filings may additionally or alternatively be used as content sources. Further, search engines related to other categories may be additionally or alternatively used as content sources. The other categories may include, for example, those directed to patents, trademarks, job postings, insider trades, earning estimates, news, discussion boards, etc.

Additionally, the information input by the user for the user's profile may also comprise the selection of the type of email system desired or required by the user. The types of email systems may be, for example, enhanced HTML, or plain text. Further, the information input by the user for the user's profile may also comprise the type of delivery schedule desired by the user. For example, the user may elect to schedule daily or weekly deliveries of reports which include the information corresponding to the items in the user list that were retrieved as a result of the search by the web site. Once the registration sequence is completed, the user is taken to their Personal Home Page screen 109. If the user selected items for their user list during the registration sequence that were previously searched in response to another user's “tracking” of the same items, then the Personal Home Page screen 109 will be initially populated with those results since those results are already stored in a storage database.

The Personal Home Page screen 109 is a custom page that is created for each user and includes the items contained in the user list as well as content summaries of information received from the plurality of content sources. Also included on the Personal Home Page screen 109 are links to take the user to screen(s) which enable the user to change the user's profile information. In addition to the elements in the profile mentioned above (e.g. list of company ticker symbols) which can be viewed, updated, and/or changed, the user may engage or disable “Auto-Login” if desired. “Auto-Login” is a feature that will automatically present the Personal Home Page screen 109 when a registered user visits the site and when “Auto-Login” is enabled. Initially, it is preferred to have “Auto-Login” enabled by default. Once “Auto-Login” is enabled, the login sequence does not require any manual intervention by the user. Using information from a cookie (as described above), the “Auto-Login” sequence 108 will authenticate the user, i.e. if the browser accepts cookies from the web server as per step 106, and take the user automatically to the user's Personal Home Page screen 109. If the browser does not accept cookies from the web server, then the user is taken to the Welcome Page Screen 104 where the user may select a path to the Username/Password screen 107. In the Username/Password screen, the user must manually input the user's username and password to gain access to their Personal Home Page screen 109. The Personal Home Page screen 109 additionally may provide a feature which enables the user to instruct the Personal Home Page screen 109 to display time-packaged results of the retrieved information corresponding to the items in the user list for the previous day, or for the entire previous week, or any time period. This will especially be useful to a user who has been away from their computer for a few days and wants to catch up on information missed while absent.

The system also allows the option to automatically suspend users who have provided an invalid email address. The system is capable of delivering over 1,000,000 messages a day. Several users may sign up with invalid email addresses that do not accept mail. When this occurs, a reply message is received in response to the attempted delivery of a message (i.e. when the delivery of the message is unsuccessful). The reply messages are stored in a temporary location. On a daily basis, the email addresses are extracted in these messages and the status in the database is changed from “active” to “inactive”. If the reply message is sent (indicating unsuccessful delivery of the message), e.g. 3 times in a row, the corresponding account is suspended and email messages are no longer delivered thereto. Thus, the system is able to automatically turn off bad email addresses periodically without intervention of the user. Existing email servers do not provide a facility for capturing the bounced messages and programming business logic (such as suspend after 3 bounces) into the system.

Once the central server receives the list of items contained in the search list from the user's profile in step 70 (FIG. 2), the central server forms a query (as per step 71), wherein the query includes, in the preferred embodiment, a string of ticker symbols combined in the disjunctive (i.e. each ticker symbol is separated by an “OR” function). Pursuant to step 72, the central server performs automatic and periodic searching using the query of the plurality of content sources (e.g. public search engines) on the WWW for information corresponding to the items contained in the search list. The central server retrieves the information (step 73) and provides the information to the storage database, where the information is formatted into a common format (step 74) using common conversion techniques which convert the incoming information from the various content sources into, for example, a document storage standard such as XML (Extensible Markup language) as explained more fully below. Then, software implemented on the central server ascertains whether the information is current (step 75) by determining whether the information corresponds to information stored in the storage database. Subsequently, only the information ascertained to be current is electronically delivered to the user (step 76). Steps 72-76 are then periodically repeated by default (step 77) unless otherwise instructed by the user. Thus, the retrieval and delivery system provides for viewing by the user of the most recent and/or updated information corresponding to each item in the search list. Preferably, the information that is electronically delivered (e.g. via email) to the user comprises a summarized report of the current information. If the email contains a summarized report, then the email may further contain links enabling the user to be taken to the user's Personal Home Page screen 109 where the current non-summarized information can be viewed. This “pushing” of information using passive searching enables the above system to notify the user via email when a change has occurred.

The present invention is capable of automatically converting data stored in one XML format into another XML format (per step 74 of FIG. 2), based solely on the information contained within the respective DTDs (Document Type Definitions). The XML standard defines a way for an organization to create its own document types such as legal, jobs, domains, patents, news, newsgroups, etc. The XML standard requires a DTD to be coded within each XML format either by embedding the DTD directly within the XML format or by referencing the location of the DTD. This latter aspect of referencing the location of the DTD is Illustrated in line 2 of the exemplary input XML code shown in Table 1. Note that this exemplary input XML code is of “legal” type. Various existing conversion software are capable of converting only one XML format into another XML format only after first manually determining the type of input XML format to be converted. Once the input XML format type is determined, then conversion software particularly dedicated to perform only conversions from one specific type of XML format to another is used for the conversion.

The present invention is capable of converting any type of input XML format (having respectively different DTD types) into an output XML format of a type which is different than that of the input XML format such as, for example, WDDX (Web Distributed Data Exchange). WDDX is another type of XML format which enables developers to pass data between heterogeneous Web servers running ASPs (Active Server Pages), Perl, Java, JavaScript or components built with Allaire's Cold Fusion application servers. WDDX is used, for example, for purposes of subsequent conversion to HTML. The conversion software used to accomplish this conversion is coded specifically with knowledge of what proper format of WDDX is acceptable (e.g. compatible with Allaire's Cold Fusion application servers) as type of output XML format. The conversion process does not require any specific knowledge of the type of input XML format (or its type of DTD). At runtime, such knowledge is derived from the input XML document's DTD. As long as a valid DTD is present for an input XML document (which, by definition, an XML document typically has a DTD coded therein), then it will be converted into a proper, optimized WDDX dictated by the conversion software. DTD is solely relied on thus making the conversion process completely flexible. The most tangible benefit of this novel approach is that XML documents can be converted into WDDX without any coding or configuration changes in the conversion software.

This implementation additionally requires no changes in order to convert new types of XML documents based upon a never-before-encountered DTD. The conversion software is able to perform the conversion of any new type (or known type for that matter) XML format by recognizing the different elements (e.g. fields) within the new (or known) type DTDs. Exemplary fields are illustrated in the exemplary DTD file shown in Table 2. The conversion software utilizes these new or known elements to develop the output XML format by processing of those elements (explained more fully below). The various existing conversion software, on the other hand, are each able to only recognize (and therefore convert) a single type of XML format. An exemplary output WDDX code is shown in Table 3.

To convert an XML format into a WDDX format, off-the shelf-software first reads the DTD (e.g. such as that shown in Table 2) provided with an input XML format (e.g. such as that shown in Table 1). The off-the-shelf software then creates a DTD data structure that contains DTD information while preserving the cardinality of the elements of the DTD. Existing off-the-shelf software is capable of performing the above steps. The following steps are then performed by the conversion software of the present invention:

Step 1

The conversion software of the present invention traverses the DTD data structure to determine whether an XML element can occur only once, zero or more times, or more than once and to determine which elements may contain sub-elements (in the sense of a recursive data structure) while ignoring elements which do not occur in the input document.

Step 2:

For every occurrence of a top-level element, output its identifier into the WDDX preamble. A “top-level element” in the XML document is an element which is not contained by any other element, with the exception of the element which defines the document. For example, if the element which defines the document is named “sleuth” and the “sleuth” document contains several elements named “LEGAL”, “QUOTE”, and “NEWS”, then these latter elements are top-level elements, but “sleuth” is not a top-level element.

The WDDX preamble is the following:

<wddxPacket version=‘0.9>
<header/>
<data>
<array length=‘NN’>
<recordset rowCount=‘RR’ fieldnames=‘F1,F2,F3,...’>
<field name=‘F1’><string>2</string></field>
<field name=‘F2’><string>3</string></field>
<field name=‘F3’><string>4</string></field>
...
</recordset>

In the above, F1, F2, F3, etc, are the identifiers of the top-level elements; e.g. “LEGAL”, “QUOTE”, and “NEWS”. This preamble creates a WDDX array where the first array item is a description of the other array items. The second and following array items are the top-level elements converted into WDDX structs and recordsets. There can be any number of these structs. In the above preamble the value of NN is the number of top-level elements plus one (to account for the preamble) and the value of RR is the number of top-level elements.

Step 3:

For each top-level element contained within the input XML document, determine which top-level elements may contain multiple occurrences of a sub-element. That is, identify which top-level elements may contain zero or more occurrences of a sub-element or more than one occurrence of a sub-element as determined in Step 1. For the sub-elements, recursively execute this step. If a sub-element can occur multiple times in its “parent” (higher-level) element, then each of the sub-elements' sub-elements is also determined to occur multiple times. This determination is made from the portion of the DTD relevant to the top-level element under examination.

Step 4:

Each top-level element of the input XML document is output as a WDDX struct. The WDDX elements created in subsequent steps are all contained within these “top-level” structs. For example, see lines 8-33 of Table 3 where a WDDX struct corresponding to the top-level element “CASE” appears.

Step 5:

For each sub-element of the top-level elements, output an appropriate WDDX element. The appropriateness of a WDDX element is derived from the following rules:

Rule A:

If an element cannot contain any sub-elements, then it is output as a WDDX var: <var name=‘ELEMENT-ID’><string>ELEMENT-CONTENT</string> where ELEMENT-ID is the identifier of the element and ELEMENT-CONTENT is the data contained within the XML element.

Rule B:

If an element contains sub-elements, none of which can occur multiple times, then it is output as a WDDX var containing a WDDX struct, where each WDDX var within the struct is a sub-element of the element and is output as in Rule A:

<var name=‘ELEMENT-ID’><struct> ...follow Rule A... </struct></var>

Rule C:

If an element (e.g. “CASE” in the exemplary input XML file shown in Table 1) may contain multiple occurrences of a sub-element, then the sub-elements which do not occur multiple times are output as a series of WDDX var as per Rule A. The sub-elements which do occur multiple times are output as per Rule D.

Rule D:

Those elements which may occur multiple times are output as a WDDX var containing a WDDX recordset. The names of the fields of the WDDX recordset are the names of the elements which can occur multiple times. The rowCount of the WDDX recordset is the maximum number of values for such elements (e.g. if the field PLAINTIFF has 32 values and the field DEFENDANT has 12 values, then the rowCount is 32). The name of the WDDX var is the name of the element containing the multiply occurring element:

```
<var name=‘PARENT-ELEMENT’>
  <recordset rowCount=‘YY’fieldNames=‘E1,E2,E3,...’>
  <field name=‘E1’>
    <string>FIELD_VALUE_E1_1</string>
    <string>FIELD_VALUE_E1_2</string>
    ....
    <string>FIELD_VALUE_E1_YY</string>
  </field>
  <field name=‘E2’>
    <string>FIELD_VALUE_E2_1</string>
    <string>FIELD_VALUE_E2_2</string>
    ...
    <string>FIELD_VALUE_E2_YY</string>
  </field>
  ...
  </recordset>
</var>
```

Step 6:

The WDDX packet is “closed” by outputting the following:

</struct>
</array>
</data>
</wddxPacket>

This output WDDX packet may then be transmitted, for example, to the recipient ColdFusion server.

It is to be understood that this particular exemplary process by the conversion software of converting an XML format to a WDDX format is for illustration purposes only. Other processes may be utilized in light of the teachings of the present invention. Such alternative processes would therefore fall within the scope of the present invention.

TABLE 1
Exemplary input XML file

```
<?xml version = ‘1.0’ encoding = ‘ISO-8859-1’?>
<!DOCTYPE legal_doc SYSTEM “http://ds01/legal.dtd”>
<legal_doc>
  <SOURCE_HREF><![CDATA[http://www.marketspan.com]]></SOURCE_HREF>
  <DOC_CREATED_DATE>2899 15:20:10</DOC_CREATED_DATE>
<CASE>
<CASE_DOCKET>MN-F-D0:99cv172</CASE_DOCKET>
<COURT_NAME><![CDATA[District Court for the District of Minnesota]]></COURT_NAME>
<COURT_TYPE>MN-F-D</COURT_TYPE>
<PLAINTIFF><![CDATA[Microsoft Corporation, A Washington Corporation]]></PLAINTIFF>
<PLAINTIFF/>
<DEFENDANT><![CDATA[James Gordon Chiodo, an Individual]]></DEFENDANT>
<DEFENDANT><![CDATA[James Gordon Chiodo, an Individual DBA Orion
Systems]]></DEFENDANT>
<CASE_CAPTION><![CDATA[Microsoft Corp v. Chiodo, et al]]></CASE_CAPTION>
<CASE_DESCRIPTION><![CDATA[Copyrights]]></CASE_DESCRIPTION>
<DATE_FILED>2/3/99</DATE_FILED>
<DATE_RETRIEVED>02/04/99</DATE_RETRIEVED>
</CASE>
</legal_doc>
```

TABLE 2
Exemplary DTD file

```
<?xml version = “1.0” encoding=‘ISO-8859-1’ ?>
<!-- This the DTD for LEGAL documents stored for the Sleuth. -->
<!ELEMENT legal_doc (SOURCE_HREF, DOC_CREATED_DATE,
CASE)>
  <!-- the url of the source e.g <a href=“URL”>SITE_NAME</a>-->
  <!ELEMENT SOURCE_HREF (#PCDATA)>
  <!-- when this document was created -->
  <!ELEMENT DOC_CREATED_DATE (#PCDATA)>
<!-- Format for Federal Litigation
    http://www.marketspan.com
-->
    <!ELEMENT CASE (CASE_DOCKET,
          COURT_NAME,
          COURT_TYPE,
          CLASS_ACTION?,
          PLAINTIFF+,
          DEFENDANT+,
          CASE_CAPTION,
          CASE_DESCRIPTION,
          DATE_FILED,
          DATE_RETRIEVED)><!-- when marketspan got it -->
    <!ELEMENT COURT_NAME (#PCDATA)>
    <!ELEMENT COURT_TYPE (#PCDATA)>
    <!ELEMENT CLASS_ACTION EMPTY>
    <!ELEMENT CASE_DOCKET (#PCDATA)>
    <!ELEMENT CASE_CAPTION (#PCDATA)>
    <!ELEMENT PLAINTIFF (#PCDATA)>
    <!ELEMENT DEFENDANT (#PCDATA)>
    <!ELEMENT CASE_DESCRIPTION (#PCDATA)>
    <!ELEMENT DATE_FILED (#PCDATA)>
    <!ELEMENT DATE_RETRIEVED (#PCDATA)>
<!ATTLIST LITIGANT type CDATA #IMPLIED>
<!ATTLIST DATE_FILED
  MONTH (Jan|Feb|Mar|Apr|May|Jun|Jul|Aug|Sep|Oct|Nov|Dec)
  #IMPLIED
  DAY CDATA #IMPLIED
  YEAR CDATA #IMPLIED
  HOUR CDATA #IMPLIED
  MIN CDATA #IMPLIED
  SEC CDATA #IMPLIED>
<!ATTLIST DATE_RETRIEVED
  MONTH (Jan|Feb|Mar|Apr|May|Jun|Jul|Aug|Sep|Oct|Nov|Dec)
  #IMPLIED
  DAY CDATA #IMPLIED
  YEAR CDATA #IMPLIED
  HOUR CDATA #IMPLIED
  MIN CDATA #IMPLIED
  SEC CDATA #IMPLIED>
```

TABLE 3
Exemplary output WDDX file

```
<wddxPacket version=‘0.9’>
<header/>
<data>
<array length=‘2’>
  <recordset rowCount=‘1’ fieldNames=‘CASE’>
    <field name=‘CASE’><string>2</string></field>
  </recordset>
  <struct>
    <var name=‘MODULE’><string>CASE</string></var>
    <var name=‘SOURCE_HREF’><string><![CDATA[http://www.marketspan.com]]></string></var>
    <var name=‘DOC_CREATED_DATE’><string><![CDATA[2899 15:20:10]]></string></var>
      <var name=‘CASE_DOCKET’><string><![CDATA[MN-F-D0:99cv172]]></string></var>
      <var name=‘COURT_NAME’><string><![CDATA[District Court for the District of
Minnesota]]></string></var>
      <var name=‘COURT_TYPE’><string><![CDATA[MN-F-D]]></string></var>
      <var name=‘CASE_CAPTION’><string><![CDATA[Microsoft Corp v. Chiodo, et
al]]></string></var>
      <var name=‘CASE_DESCRIPTION’><string><![CDATA[Copyrights]]></string></var>
      <var name=‘DATE_FILED’><string><![CDATA[2/3/99]]></string></var>
      <var name=‘DATE_RETRIEVED’><string><![CDATA[02/04/99]]></string></var>
    <var name=‘CASE’>
      <recordset rowCount=‘2’ fieldNames=‘PLAINTIFF,DEFENDANT’>
      <field name=‘DEFENDANT’>
        <string><![CDATA[James Gordon Chiodo, an Individual]]></string>
        <string><![CDATA[James Gordon Chiodo, an Individual DBA Orion Systems]]></string>
      </field>
      <field name=‘PLAINTIFF’>
        <string><![CDATA[Microsoft Corporation, A Washington Corporation]]></string>
        <string><![CDATA[]]></string>
      </field>
      </recordset>
    </var>
  </struct>
</array>
</data>
</wddxPacket>
```

The system uses “web agents” that allow the automated retrieval of content from another computer on the Internet. Agents are software programs that can programmatically access web pages. The software connects to a series of web servers and downloads designated pages. The URL (Universal Resource Locator) of the web pages to be downloaded are provided to the agent as their input. The output of the agent software is the text of the web page. The agents software programmatically retrieves the web pages by utilizing the standard LWP (Library for WWW Programming) Perl module. This module performs all the tasks required such as creating a connection with the remote web server and requesting the web page. The agents will take the retrieved web page and filter the text for the required content. The agent software is located on remote servers 251, 252, 253 shown in the exemplary information search, retrieval and delivery system 240 depicted in FIG. 8. In this system, agents, through remote servers 251, 252, 253, are able to be accessed and controlled remotely through the Internet 50. An exemplary code from the LWP distribution representing the creation of a web agent is shown in Table 4. This exemplary code shows how the user agent, a request, and a response are represented in actual perl code.

TABLE 4
Actual perl code representing an exemplary creation of a web agent

# Create a user agent object
use LWP::UserAgent;
$ua = new LWP::UserAgent;
$ua->agent(“AgentName/0.1 ” . $ua->agent);
# Create a request
my $req = new HTTP::Request POST => ‘http://www.perl.com/cgi-bin/
BugGlimpse’;
$req->content_type(‘application/x-www-form-urlencoded’);
$req->content(‘match=www&errors=0’);
# Pass request to the user agent and get a response back
my $res = $ua->request($req);
# Check the outcome of the response
if ($res->is_success) {
print $res->content;
} else {
print “Bad luck this time\n”;
}

When used over the Internet, web agents can retrieve content from any WWW server. Web agents allow a user to retrieve web-based content and execute a Common Gateway Interface (CGI) or other programs in an automated fashion. CGI is a standard for running external programs from a World Wide Web server. Traditional web agents have the shortcoming of not having the capability to maintain a “history” of content that they have retrieved over the Internet. For example, if a web agent is deployed on the Wall Street Journal home page, it will retrieve the content from the Journal home page and return it to the user. The agent does not keep track of the content in the page. So, if the page has not changed between the interval the agent runs on (e.g. daily), the user of the agent will receive the same content twice. The new generation of existing web agents have overcome this problem by maintaining a “history” of previously retrieved content. So, in the previous example, the agent would be able to recognize that the page has not been updated and will communicate this to the user of the agent. This ability to maintain history is what separates the so called “intelligent” agents from traditional web agents.

The technology used to maintain history is the key differentiator of intelligent agents. The existing intelligent agents maintain history by keeping a complete copy of the content locally on disk. Then, when the agent retrieves new content from the target location, it is able to compare the contents of the locally stored items with the just retrieved content. If there is a change in the content, the agent can communicate this to the user. The present invention takes a novel approach to maintaining history. The entire content of the retrieved page is not stored. Instead, a “signature” is developed which is much smaller than the complete page, but captures the “essence” or significant portions of the page content. A signature is developed by extracting portions of the page that interest the user and creating a “hash” of those portions.

A hash or hash-coding is a scheme for providing rapid access to data items which are distinguished by some key. Each data item to be stored is associated with a key. A hash function is applied to the item's key and the resulting hash value is used as an index to select one of a number of “hash buckets” in a hash table. The table contains pointers to the original items. If the hash table already has an entry at the indicated location then that entry's key must be compared with the given key to see if it is the same. If two items' keys hash to the same value (a “hash collision”) then some alternative location is used (e.g. the next free location cyclically following the indicated one). For best performance, the table size and hash function must be tailored to the number of entries and range of keys to be used. The hash function usually depends on the table size so if the table needs to be enlarged it must usually be completely rebuilt. In an exemplary hash, the headline “Acme announces earnings estimates” can be input (e.g. as ASCII code) to a hash function which outputs a single-word hash value such as “*!%f2&”. This hash value can subsequently be used to retrieve the complete headline via lookup of the hash value in a database. Optionally, when it becomes necessary to distinguish between similar headlines, optional data (e.g. the company's ticker symbol) may be added to the headline prior to the application of the hash function thereto. In this example, “ACME/Acme announces earnings estimates” (where “ACME” is the company's ticker symbol) would be input to the hash function. Alternatively (or additionally), the release date of the headline may be added to the headline prior to the application of the hash function thereto. In this particular example, “Sep. 18, 1999/Acme announces earnings estimates” would be input to the hash function.

So, in the examples above, if the user was only interested in news headlines on the Wall Street Journal, the agent would extract only the headlines from the page and compose a hash of its content. The size of this hash, or signature, is typically less than 5% of the size of the total page. The signature of the content is stored in a Relational Database Management System (RDBMS) such as Oracle rather than on disk. RDBMS interfaces are then able to be used to access the signature information instead of relying on local disk access.

In the present invention, document servers capable of delivering hundreds of documents simultaneously are used. A document server is a multi-threaded service whose task it is to deliver documents to a target service from a “document store”. Typically, a document store is a hard disk drive system that is capable of storing several gigabytes of data. The document server retrieves documents from the store and transmits the document to the target service using a transportation protocol. The document server retrieves documents from the document store which can be located anywhere on the Internet and delivers them to the front-end web servers where they are delivered to the end-user. The document server consists of software embedded within a web server that is multi-threaded. The web server is responsible for creating additional threads as required. The web server delivers documents between tiers using a cache. The cache is an in-memory mini-document store that holds frequently accessed documents. Using a cache reduces the effort required by the web server since it no longer requires a disk access. Also, the present invention uses an Internet protocol (e.g. HTTP) to access the document store. This allows the documents to be stored anywhere on the Internet, but process them just like they were local files. This web-based document management system allows agents to be run and files to be stored anywhere on the Internet.

The present invention uses “clustering” technology that allows agents to be run on several local desktop PC's and perform several hundred web retrievals simultaneously. Clustering is the concept of combining a group of servers (i.e. that are each located in different locations from one another) into a single virtual server. The concept of combining a group of servers into a single virtual server is well known in the art. As described above, the document server is capable of retrieving documents from anywhere on the Internet. This allows agents to be run anywhere on the Internet. In accordance with the present invention, a group of servers each located in different locations from one another are utilized to create a distributed environment where several different locations are contributing content for the document server. Each of the servers in the group of servers are capable of simultaneously retrieving different information from the Internet. Existing services that deliver content are based on web agents that operate locally to deliver content. A system has therefore been created that allows a distributed environment for the agents. The agents can run from any location and the document server 44 (FIG. 8) is responsible for gathering the documents as if they were local and presenting them to the user.

Furthermore, it is to be understood that although the present invention has been described with reference to a preferred embodiment, various modifications, known to those skilled in the art, may be made to the structures and process steps presented herein without departing from the invention as recited in the several claims appended hereto. For example, instead of searching the public search engines for information corresponding to companies contained in the search list, public search engines may be searched for information regarding jobs available which correspond to job formats/criteria as the items contained in the user list. Thus, an automatic and periodic job search technique is alternatively provided.

What is claimed is:

1. A method for automated processing of a search list provided by a remote user, and retrieving and delivering information corresponding to at least one item contained in said search list, comprising the steps of:
(A) receiving, onto a central server that services a plurality of remote users, a search list provided by the user, said search list comprising at least one item;
(B) forming a query at the central server based on the search list;
(C) periodically performing the following steps:
(i) initiating, from the central server, a search using the query on two or more information sources on the World Wide Web in order to locate information corresponding to each of said at least one item;
(ii) retrieving, with the central server, said information;
(iii) formatting said information into a common format using the central server;
(iv) ascertaining whether said information is current by comparing said information in the common format to information stored in a storage database in the common format, wherein the information stored in the database corresponds to results of previous searches using the query; and
(v) after step (iv), electronically delivering, using said central server, only said information ascertained to be current to the remote user.

2. The method of claim 1, wherein said step of initiating is performed automatically.

3. The method of claim 1, wherein said search list may be selectively edited by said user at any time.

4. The method of claim 1, wherein the selection of said two or more information sources to be searched are determined by said user and may be selectively edited by said user at any time.

5. The method of claim 1, wherein each of said two or more information sources to be searched are determined independently by said user for each of said at least one item.

6. The method of claim 1, wherein said step of initiating is performed at predetermined time intervals determined by said user, said predetermined time intervals capable of being selectively edited by said user at any time.

7. The method of claim 1, wherein said step of electronically delivering is automatically performed via electronic mail.

8. The method of claim 1, wherein each of said at least one item corresponds to a distinct company.

9. The method of claim 1, wherein each of said at least one item corresponds to a distinct industry

10. The method of claim 1, wherein each of said at least one item corresponds to a distinct job format.

11. The method of claim 1, wherein said two or more information sources are public search engines.

12. A system for automated processing of a search list provided by a remote user, and retrieving and delivering information corresponding to at least one item contained in said search list, comprising:
a storage database that stores information in a common format, wherein information stored in the database corresponds to results of previous searches using a query; and
a central server that receives a search list provided by the user and comprising at least one item, services a plurality of remote users, forms the query based on the search list, and periodically initiates a search using the query on two or more information sources on the World Wide Web in order to locate information corresponding to each of said at least one item, retrieves said information, formats said information into a common format, ascertains whether said information is current by comparing said information in the common format to said information stored in said database in the common format, and electronically delivers only said information ascertained to be current to the remote user.

13. The system of claim 12, wherein said central server periodically initiates the searches automatically.

14. The system of claim 12, wherein said search list may be selectively edited by said user at any time.

15. The system of claim 12, wherein the selection of said two or more information sources to be searched are determined by said user and may be selectively edited by said user at any time.

16. The system of claim 12, wherein each of said two or more information sources to be searched are determined independently by said user for each of said at least one item.

17. The system of claim 12, wherein said central server periodically initiates the searches at predetermined time intervals determined by said user, said predetermined time intervals capable of being selectively edited by said user at any time.

18. The system of claim 12, wherein said central server electronically delivers said information via an electronic mail system.

19. The system of claim 12, wherein each of said at least one item corresponds to a distinct company.

20. The system of claim 12, wherein each of said at least one item corresponds to a distinct industry

21. The system of claim 12, wherein each of said at least one item corresponds to a distinct job format.

22. The system of claim 12, wherein said two or more information sources are public search engines.

23. A computer-readable medium tangibly embodying instructions which, when executed by a computer, implement a process comprising the steps of:
(A) receiving, onto a central server that services a plurality of remote users, a search list provided by the user, said search list comprising at least one item;
(B) forming a query at the central server based on the search list;
(C) periodically performing the following steps:
(i) initiating, from the central server, a search using the query on two or more information sources on the World Wide Web in order to locate information corresponding to each of said at least one item;
(ii) retrieving, with the central server, said information;
(iii) formatting said information into a common format using the central server;
(iv) ascertaining whether said information is current by comparing said information in the common format to information stored in a storage database in the common format, wherein the information stored in the database corresponds to results of previous searches using the query; and
(v) after step (iv), electronically delivering, using said central server, only said information ascertained to be current to the remote user.

24. A method for ascertaining whether information retrieved from the World Wide Web is current, comprising the steps of:
(A) initiating, from a central server, a search using a query on at least one information source on the World Wide Web in order to locate information corresponding to at least one item from which the query is based;
(B) retrieving, with the central server, a portion of said information;
(C) composing, on the central server, a hash of said portion; and
(D) ascertaining whether said information is current by comparing said hash to hashes stored in a storage database, wherein the hashes stored in the database corresponds to results of previous searches using the query.

25. A method for converting a document from one extensible markup language (XML) format to another XML format, comprising the steps of:
(A) retrieving, with a central server, a first document in a first input XML format, wherein said first document in said first input XML format is coded with a first document type definition (DTD);
(B) converting said first document from said first input XML format to another XML format using only information derived from said first DTD;
(C) retrieving, with said central server, a second document in a second input XML format different from said first input XML format, wherein said second document in said second input XML format is coded with a second DTD different from said first DTD; and
(D) converting said second document from said second input XML format to said another XML format using only information derived from said second DTD.

26. The method of claim 25, wherein said another XML format is a web distributed data exchange (WDDX) format.

27. A method for processing of a search list provided by a remote user, and retrieving information corresponding to at least one item contained in said search list, comprising the steps of:
(A) receiving, onto a central server that services a plurality of remote users, a search list provided by the user, said search list comprising at least one item;
(B) forming a query at the central server based on the search list;
(C) initiating, from the central server, a search using the query on at least one information source on the World Wide Web in order to locate information corresponding to each of said at least one item; and
(D) retrieving, with the central server, said information;
wherein said central server comprises at least two local servers such that said at least two local servers function as a single virtual server, wherein each of said at least two servers are located in different locations from one another, each of said at least two servers capable of simultaneously retrieving different portions of said information.

28. A method for automatically suspending the electronic delivery of information to electronic mail destinations having invalid electronic mail addresses, comprising the steps of:
(A) attempting to electronically deliver information in the form of a message on a periodic basis from a server to an electronic mail destination using an electronic mail address corresponding to said electronic mail destination;
(B) receiving a reply message in response to the attempted delivery of said message in step (A) when said electronic delivery of said message is unsuccessful;
(C) extracting said electronic mail address from said reply message;
(D) change the status of said electronic mail address from valid to invalid after a predetermined number of reply messages are received corresponding to the same electronic mail address; and
(E) suspending the electronic delivery of information to said electronic mail destination when the status of said electronic mail address is held invalid.

29. The method of claim 28, wherein said reply message is a copy of said message attempted to be delivered in step (A).

30. The method of claim 28, wherein said reply message includes therein a statement indicating that said delivery of said message attempted in step (A) was unsuccessful.

31. A system for ascertaining whether information retrieved from the World Wide Web is current, comprising:
a storage database that stores hashes, wherein hashes stored in the database correspond to results of previous searches using a query;
a central server that initiates a search using the query on at least one information source on the World Wide Web in order to locate information corresponding to at least one item from which the query is based, retrieves a portion of said information, composes a hash of said portion, and ascertains whether said information is current by comparing said composed hash to the hashes stored in the database.

32. A system for converting a document from one extensible markup language (XML) format to another XML format, comprising:
a central server that retrieves a first document in a first input XML format, wherein said first document in said first input XML format is coded with a first document type definition (DTD), said central server converts said first document from said first input XML format to another XML format using only information derived from said first DTD, said central server retrieves a second document in a second input XML format different from said first input XML format, wherein said second document in said second input XML format is coded with a second DTD different from said first DTD, said central server converts said second document from said second input XML format to said another XML format using only information derived from said second DTD.

33. The system of claim 32, wherein said another XML format is a web distributed data exchange (WDDX) format.

34. A system for processing of a search list provided by a remote user, and retrieving information corresponding to at least one item contained in said search list, comprising:
a central server that receives a search list provided by the user and comprising at least one item, services a plurality of remote users, forms a query based on the search list, initiates a search using the query on at least one information source on the World Wide Web in order to locate information corresponding to each of said at least one item, and retrieves said information;
wherein said central server comprises at least two local servers such that said at least two local servers function as a single virtual server, wherein each of said at least two servers are located in different locations from one another, each of said at least two servers capable of simultaneously retrieving different portions of said information.

35. A system for automatically suspending the electronic delivery of information to electronic mail destinations having invalid electronic mail addresses, comprising:
a server that attempts to electronically deliver information in the form of a message on a periodic basis to an electronic mail destination using an electronic mail address corresponding to said electronic mail destination, receives a reply message in response to the attempted delivery of said message when said electronic delivery of said message is unsuccessful, extracts said electronic mail address from said reply message, changes the status of said electronic mail address from valid to invalid after a predetermined number of reply messages are received corresponding to the same electronic mail address, and suspends the electronic delivery of information to said electronic mail destination when the status of said electronic mail address is held invalid.

36. The system of claim 35, wherein said reply message is a copy of said message attempted to be delivered.

37. The system of claim 35, wherein said reply message includes therein a statement indicating that said delivery of said message was unsuccessful.
